(19) United States
(12) Patent Application Publication
(10) Pub. No.: US 2021/0075071 A1
(43) Pub. Date: Mar. 11, 2021

(54) BATTERY CELL MODULE

(71) Applicant: Cheng Uei Precision Industry Co., Ltd., New Taipei City (TW)

(72) Inventors: PING-YU LEE, New Taipei City (TW); TSAI-FU LIN, New Taipei City (TW); MING-CHUN CHANG, New Taipei City (TW); PO-SHEN CHEN, New Taipei City (TW); TA-CHANG YANG, New Taipei City (TW); MIN-YU WU, New Taipei City (TW)

(21) Appl. No.: 16/711,420

(22) Filed: Dec. 11, 2019

(30) Foreign Application Priority Data
Sep. 6, 2019 (CN) 201921485378.X

(51) Int. Cl. H01M 10/613; H01M 2/02; H01M 2/04; H01M 2/10

(52) U.S. Cl. CPC H01M 10/613; H01M 2/029; H01M 2/1094; H01M 2/0478; H01M 2/0277

(57) ABSTRACT

A battery cell module of the present invention includes: a plurality of battery assemblies, each having several battery cells; a flame-retardant unit, covered on an external surface of each of the battery cells; a first bracket, having a first fixation plate in grid pattern, the first fixation plate having a plurality of first containing slots corresponding to the plurality of the battery assemblies; a second bracket, connected with the first bracket and having a second fixation plate in grid pattern, the second fixation plate having a plurality of second containing slots corresponding to the plurality of the first containing slots; wherein an end of each of the battery cells is mounted in each of the plurality of the first containing slots, the other end of each of the battery cells is mounted in each of the plurality of the second containing slots.

### BACKGROUND OF THE INVENTION

### 1. Field of the Invention

The present application is based on, and claims priority from, China application number 201921485378.X, filed Sep. 6, 2019, the disclosure of which is hereby incorporated by reference herein in its entirety. The present invention generally relates to a battery cell module, and more particularly to a battery cell module having a flame-retardant unit capable of avoiding flame propagation.

### 2. Related Art

In energy-dense lithium-ion battery cell module system, battery cells easily become unstable and lead to explosion under the influence of external impact such as heat, shock, collision, etc. Because of closer stacking of the battery cells, as soon as one of the battery cells appears battery cell failure and thermal runaway, the whole battery cell module would be readily burned and generate a heat that causes uncontrollable chain reactions or even an explosion, which leads to an unexpected result and a loss of the whole battery cell module.

Therefore, there is a need to provide a battery cell module, capable of protecting normal battery cells from being affected by a faulty battery cell which causes a short circuit and a temperature raising under the influence of external impact to prevent the battery cells in the battery cell module from thermal runaway for insuring security of the battery cell module.

### SUMMARY OF THE INVENTION

An object of the present invention is to provide a battery cell module, which provides a flame-retardant unit to avoid the spread of battery cell failure.

To attain this, a battery cell module of the present invention includes: a plurality of battery assemblies, each having several battery cells; a flame-retardant unit, covered on an external surface of each of the battery cells; a first bracket, having a first fixation plate in grid pattern, the first fixation plate having a plurality of first containing slots corresponding to the plurality of the battery assemblies; a second bracket, connected with the first bracket and having a second fixation plate in grid pattern, the second fixation plate having a plurality of second containing slots corresponding to the plurality of the first containing slots; wherein an end of each of the battery cells of each of the plurality of the battery assemblies is mounted in each of the plurality of the first containing slots, the other end of each of the battery cells of each of the plurality of the battery assemblies is mounted in each of the plurality of the second containing slots.

Accordingly, the battery cell module consists of fourteen battery assemblies connected in series, each of the fourteen battery assemblies consists of six battery cells connected in parallel, a positive pole and a negative pole of each of the fourteen battery assemblies are arranged alternatively.

Accordingly, the first bracket is protruded outwardly to form a plurality of bumps, each of the plurality of the bumps has a mounting hole, the second bracket is protruded outwardly to form a plurality of connection parts, each of the plurality of the connection parts is further protruded outwardly to form a plurality of fixation portions, each of the plurality of the fixation portions is arranged corresponding to each of the plurality of the mounting holes.

Accordingly, the flame-retardant unit includes a sticky coating and an outer layer, the sticky coating made by means of a calendering process and made up of a mixture of a gel, a macromolecule material, a first additive and a second additive, wherein the gel is a soft material and is made of silicon that is present in a form of gummy material, the silicon remains a pure mixture without including any bridging agent, the macromolecule material, the first additive and the second additive are respectively disposed in the gel, the outer layer is disposed on a side of the sticky coating to provide a side of the flame-retardant unit with viscosity, and the other side of the flame-retardant unit has no viscosity.

Accordingly, the gel is made of silicon that is present with an amount of 30-50 wt %.

Accordingly, the macromolecule material is a composite material composed of nano silica (SiO₂) and nano clay, wherein the composite material composed of the nano silica and the nano clay is present in an amount of 3-10 wt %.

Accordingly, the first additive is aluminum hydroxide (Al(OH)₃.nH₂O) and is present in an amount of 40-60 wt %.

Accordingly, the second additive is magnesium hydroxide (Mg(OH)₂.nH₂O) and is present in an amount of 5-40 wt %.

Accordingly, the outer layer is a tape.

As above, the external surface of each of the battery cells is covered by the flame-retardant unit so as to provide each of the battery cells with stability and favourable effect on avoiding flame propagation and explosion, as well as on uniform heat transfer and dissipation. When battery cell failure occurs in the battery cells and causes a short circuit and a temperature raising, the flame-retardant unit is disposed to resist thermal conductivity of a faulty battery cell in the battery cells to avoid overheat of normal battery cells adjacent to the faulty battery cell for the protection of the normal battery cells in the battery cell module from being affected by the temperature raising, and thus to reduce the loss in case of battery cell failure.

### BRIEF DESCRIPTION OF THE DRAWINGS

FIG. 1 is a perspective view showing a battery cell module in accordance with the present invention;

FIG. 2 is an exploded perspective view of FIG. 1;

FIG. 3 is a perspective view showing a flame-retardant unit is covered on a battery cell; and

FIG. 4 is a schematic view showing components of the flame-retardant unit.

### DESCRIPTION OF THE PREFERRED EMBODIMENTS

In order to describe the technical contents, structural features, purpose to be achieved and the effectiveness of the present invention, the detailed description is given with schema below.

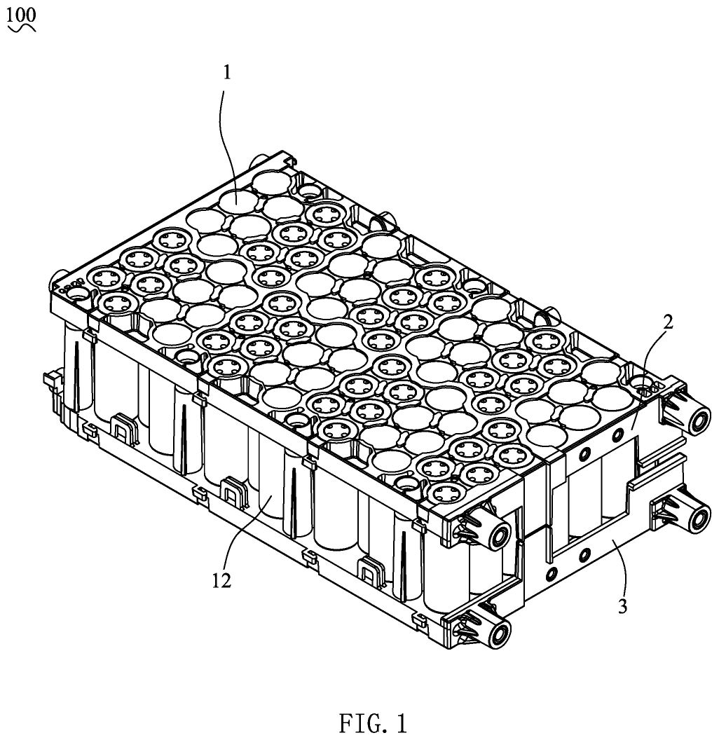

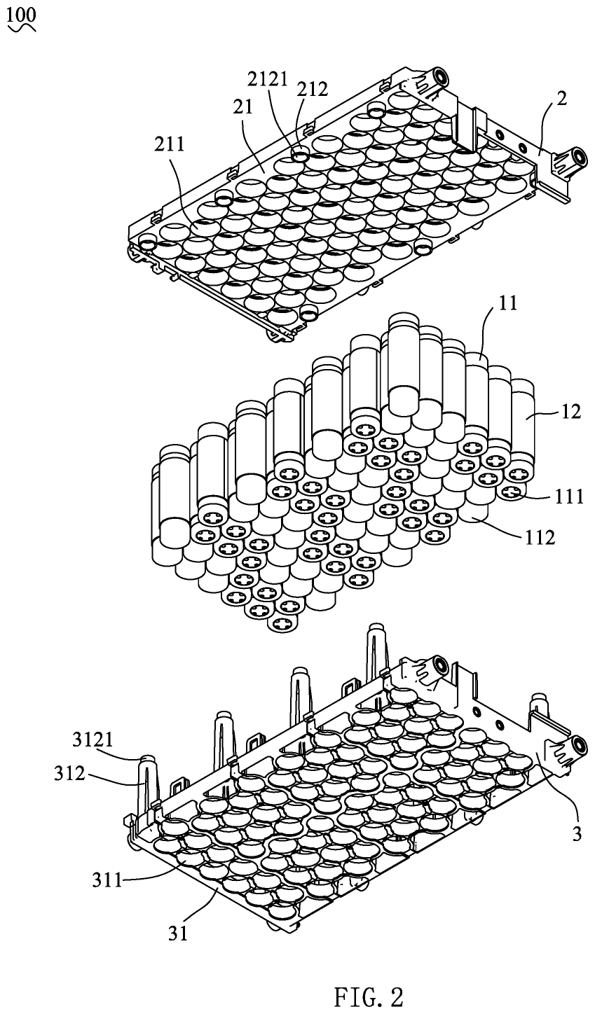

Referring to FIG. 1 and FIG. 2, a battery cell module 100 of the present invention comprises a plurality of battery assemblies 1, a first bracket 2 and a second bracket 3.

Each of the plurality of the battery assemblies 1 has several battery cells 11. An external surface of each of the battery cells 11 is covered by a flame-retardant unit 12.

Each of the battery cells 11 has both ends, one end is a positive pole 111 and the other end is a negative pole 112. The flame-retardant unit 12 includes a sticky coating 121 and an outer layer 122.

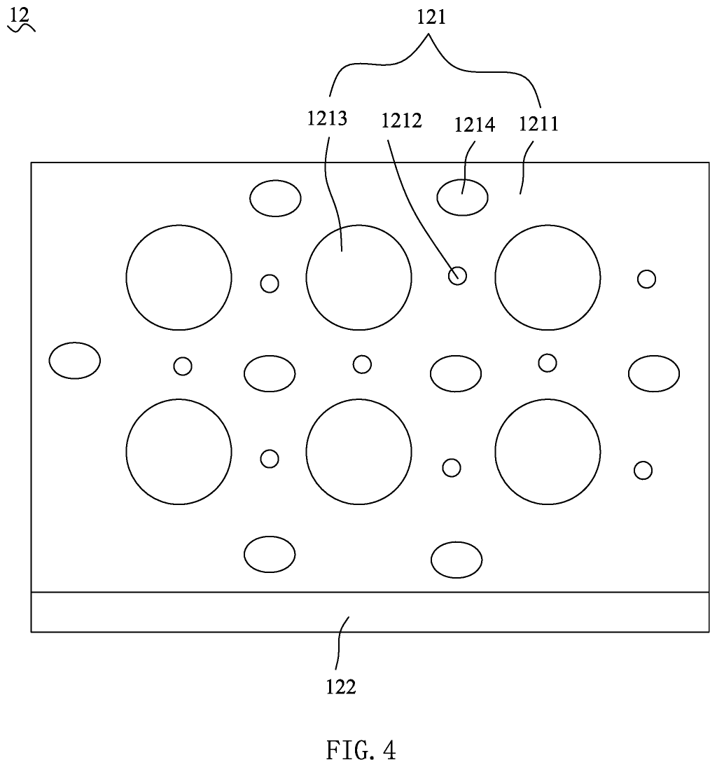

With reference to FIG. 4, the sticky coating 121 is made up of a mixture of a gel 1211, a macromolecule material 1212, a first additive 1213 and a second additive 1214. The gel 1211 is a soft material. More specifically, the gel 1211 is made of silicon that is present in a form of gummy material with an amount of 30-50 wt %. Said silicon does not include any bridging agent and thus induces no crosslinking reaction, so the silicon is self-adhesive and is able to be pasted on each of the plurality of the battery cells 11. Furthermore, because no chemical reaction occurs such as the crosslinking reaction, the silicon remains a pure mixture. As long as there is no functional damage, the silicon can be produced ceaselessly and is recyclable for reuse.

The macromolecule material 1212 is disposed in the gel 1211. The macromolecule material 1212 has a thermal resistance property and involves thermal conducting materials. In this embodiment, the macromolecule material 1212 is solid. The macromolecule material 1212 is a composite material composed of nano silica (SiO₂) and nano clay. More specifically, the composite material composed of the nano silica and the nano clay is present in an amount of 3-10 wt %. When heated, the composite material gathers at an end in contact with a flame to form a block layer consisted of the nano silica and the nano clay for blocking the flame.

The first additive 1213 is disposed in the gel 1211. The first additive 1213 is aluminum hydroxide (Al(OH)₃.nH₂O). The aluminum hydroxide is a solid material. More specifically, the aluminum hydroxide is present in an amount of 40-60 wt %. When heated to 130° C., the aluminum hydroxide decomposes into aluminum oxide (Al₂O₃) of less volume. Because of volume change, a phase change (from solid to gas) occurs, thereby forming voids in the flame-retardant unit 12 to block the flame.

The second additive 1214 is disposed in the gel 1211. The second additive 1214 is magnesium hydroxide (Mg(OH)₂.nH₂O). The magnesium hydroxide is solid. More specifically, the magnesium hydroxide is present in an amount of 5-40 wt %. When heated to 150° C., the magnesium hydroxide decomposes into magnesium oxide (MgO) of less volume. Because of volume change, a phase change (from solid to gas) occurs, thereby forming voids in the flame-retardant unit 12 to block the flame.

Because the macromolecule material 1212, the first additive 1213 and the second additive 1214 are solid, they are needed to be covered by the gel 1211. After being processed by a processing equipment, the flame-retardant unit 12 is formed in a piece shape.

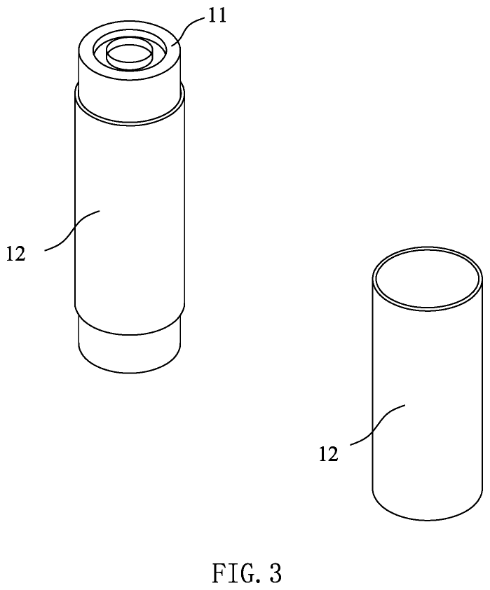

With reference to FIG. 3 and FIG. 4, the outer layer 122 is disposed on a side of the sticky coating 121 to provide a side of the flame-retardant unit 12 with viscosity. The other side of the flame-retardant unit 12 has no viscosity. More specific, the outer layer 122 is a tape. When the outer layer 122 is pasted on the side of the sticky coating 121, a stiffness of the flame-retardant unit 12 of the present invention is increased. Therefore, the flame-retardant unit 12 can steadily wrap each of the plurality of the battery cells 11 or other products to facilitate processing operations.

In this embodiment, each of the plurality of the battery assemblies 1 has six battery cells 11. A middle part of an external surface of each of the battery cells 11 is covered by a flame-retardant unit 12.

The first bracket 2 has a first fixation plate 21 in grid pattern. The first fixation plate 21 has a plurality of first containing slots 211 corresponding to the plurality of the battery assemblies 1. The first bracket 2 is protruded outwardly to form a plurality of bumps 212. Each of the plurality of the bumps 212 has a mounting hole 2121.

The second bracket 3 has a second fixation plate 31 in grid pattern. The second fixation plate 31 has a plurality of second containing slots 311 corresponding to the plurality of the first containing slots 211. The second bracket 3 is protruded outwardly to form a plurality of connection parts 312. Each of the plurality of the connection parts 312 is further protruded outwardly to form a plurality of fixation portions 3121. Each of the plurality of the fixation portions 3121 is arranged corresponding to each of the plurality of the mounting holes 2121.

An end of each of the battery cells 11 of each of the plurality of the battery assemblies 1 is mounted in each of the plurality of the first containing slots 211. The other end of each of the battery cells 11 of each of the plurality of the battery assemblies 1 is mounted in each of the plurality of the second containing slots 311. Each of the plurality of the fixation portions 3121 is arranged in the corresponding mounting hole 2121. Therefore, the plurality of the battery assemblies 1, the first bracket 2 and the second bracket 3 are combined with each other as the battery cell module 100 of the present invention.

In this embodiment, the battery cell module 100 of the present invention is established in a fourteen-series and six-parallel mixed mode. The battery cell module 100 consists of fourteen battery assemblies 1 connected in series. Each of the fourteen battery assemblies 1 consists of six battery cells 11 connected in parallel. The positive pole 111 and the negative pole 112 of each of the fourteen battery assemblies 1 are arranged alternatively.

The flame-retardant unit 12 is covered at the external surface of each of the battery cells 11, so when the battery cells 11 are combined with each other as the battery cell module 100 of the present invention, as soon as battery cell failure occurs in the battery cells 11 and causes a short circuit and a temperature raising under the influence of external impact, the flame-retardant unit 12 is disposed to resist thermal conductivity of a faulty battery cell in the battery cells 11 to avoid overheat of normal battery cells adjacent to the faulty battery cell. It is known from experimental results that when the temperature of the faulty battery cell raises to 800° C., the normal battery cells adjacent to the faulty battery cell are heated up to 200° C. only. Therefore, the flame-retardant unit 12 prevents the faulty battery cell to affect the adjacent normal battery cells and thus to reduce the loss in case of battery cell failure.

Because the battery cells 11 easily become unstable and leads to explosion under the influence of heat, shock, collision, the flame-retardant unit 12 with uniform heat transfer and dissipation is provided to cover the external surface of each of the battery cells 11, capable of protecting the battery cells 11 from flame propagation and explosion. The material combination described in this embodiment has a thermal conductivity of 1.02 W/m° C.

As above, the external surface of each of the battery cells 11 is covered by the flame-retardant unit 12 so as to provide each of the battery cells 11 with stability and favourable effect on avoiding flame propagation and explosion, as well as on uniform heat transfer and dissipation. When battery cell failure occurs in the battery cells 11 and causes a short circuit and a temperature raising, the flame-retardant unit 12 is disposed to resist thermal conductivity of a faulty battery cell in the battery cells 11 to avoid overheat of normal battery cells adjacent to the faulty battery cell for the protection of the normal battery cells in the battery cell module 100 from being affected by the temperature raising, and thus to reduce the loss in case of battery cell failure.

What is claimed is:

1. A battery cell module, including:
a plurality of battery assemblies, each having several battery cells;
a flame-retardant unit, covered on an external surface of each of the battery cells;
a first bracket, having a first fixation plate in grid pattern, the first fixation plate having a plurality of first containing slots corresponding to the plurality of the battery assemblies; and
a second bracket, connected with the first bracket and having a second fixation plate in grid pattern, the second fixation plate having a plurality of second containing slots corresponding to the plurality of the first containing slots;
wherein an end of each of the battery cells of each of the plurality of the battery assemblies is mounted in each of the plurality of the first containing slots, the other end of each of the battery cells of each of the plurality of the battery assemblies is mounted in each of the plurality of the second containing slots.

2. The battery cell module of claim 1, wherein the battery cell module consists of fourteen battery assemblies connected in series, each of the fourteen battery assemblies consists of six battery cells connected in parallel, a positive pole and a negative pole of each of the fourteen battery assemblies are arranged alternatively.

3. The battery cell module of claim 1, wherein the first bracket is protruded outwardly to form a plurality of bumps, each of the plurality of the bumps has a mounting hole, the second bracket is protruded outwardly to form a plurality of connection parts, each of the plurality of the connection parts is further protruded outwardly to form a plurality of fixation portions, each of the plurality of the fixation portions is arranged corresponding to each of the plurality of the mounting holes.

4. The battery cell module of claim 1, wherein the flame-retardant unit includes a sticky coating and an outer layer, the sticky coating made by means of a calendering process and made up of a mixture of a gel, a macromolecule material, a first additive and a second additive, wherein the gel is a soft material and is made of silicon that is present in a form of gummy material, the silicon remains a pure mixture without including any bridging agent, the macromolecule material, the first additive and the second additive are respectively disposed in the gel, the outer layer is disposed on a side of the sticky coating to provide a side of the flame-retardant unit with viscosity, and the other side of the flame-retardant unit has no viscosity.

5. The battery cell module of claim 1, wherein the gel is made of silicon that is present with an amount of 30-50 wt %.

6. The battery cell module of claim 4, wherein the macromolecule material is a composite material composed of nano silica (SiO₂) and nano clay, wherein the composite material composed of the nano silica and the nano clay is present in an amount of 3-10 wt %.

7. The battery cell module of claim 4, wherein the first additive is aluminum hydroxide (Al(OH)₃.nH₂O) and is present in an amount of 40-60 wt %.

8. The battery cell module of claim 4, wherein the second additive is magnesium hydroxide (Mg(OH)₂.nH₂O) and is present in an amount of 5-40 wt %.

9. The battery cell module of claim 4, wherein the outer layer is a tape.
